(19) United States
(12) Patent Application Publication
(10) Pub. No.: US 2026/0350501 A1
(43) Pub. Date: Nov. 5, 2026

(54) SELF-CHECKOUT (SCO) TERMINAL CASH MANAGEMENT OPTIMIZATION

(71) Applicant: NCR Voyix Corporation, Atlanta, GA (US)

(72) Inventors: Itamar David Laserson, Givat Shmuel (IL); Shay Marom, Kiryat Tiv’on (IL)

(21) Appl. No.: 19/194,310

(22) Filed: Apr. 30, 2025

(51) Int. Cl. G06Q 10/0631

(52) U.S. Cl. CPC G06Q 10/06312; G06Q 10/06315

(57) ABSTRACT

Machine learning techniques enhance cash management optimization in retail environments by incorporating activity policy constraints. A first machine learning model (MLM) generates optimal media baselines for terminals while a second MLM produces recommendations considering retailer-specific operational constraints like synchronization requirements and scheduling policies. The methods and system support various cash management modes including central versus store-level management, internal versus external replenishments, different lane formats, and overflow policies. This comprehensive approach improves operational efficiency by minimizing cash activities while adhering to practical operational limitations, ultimately providing implementable cash management schedules tailored to each retailer's specific operational framework.

### BACKGROUND

A major challenge for retail store managers is effectively managing cash levels at self-checkout (SCO) lanes. Current mechanisms for triggering warnings of low or excess cash are suboptimal, leading to inefficient cash management practices such as replenishing or removing cash during peak store hours, degrading lanes to card-only mode, or shutting down lanes entirely. While previous solutions have addressed real-time alerts and short-term forecasting, retailers face additional complexities due to varying operational constraints, including different modes of cash servicing, cash management policies, and lane format applications that impact how and when cash activities can be performed.

### BRIEF DESCRIPTION OF THE DRAWINGS

FIG. 1 is a diagram of a system for terminal cash management optimization, according to an example embodiment.

FIG. 2 is a flow diagram of a method for terminal cash management optimization, according to an example embodiment.

FIG. 3 is a flow diagram of another method for terminal cash management optimization, according to an example embodiment.

### DETAILED DESCRIPTION

Retail store operations face significant challenges in managing cash levels at self-checkout (SCO) terminals, which can substantially impact operational efficiency, customer satisfaction, and overall profitability. The consequences of suboptimal cash service activities at SCO terminals manifest in multiple ways. First, each cash activity requires several minutes (5-15 minutes) to complete, accumulating to several hours per store per month in labor costs. Second, performing service activities during store hours renders lanes inoperable, reducing availability to shoppers and increasing wait times. Third, suboptimal cash pickup and delivery schedules can result in higher costs or cash shortages for replenishments. Fourth, improper cash levels may prevent providing correct change to customers, necessitating attendant intervention or redirecting customers to different lanes.

Current cash management systems face significant computational challenges in coordinating multiple self-checkout terminals under complex operational constraints. The problem extends beyond simple cash level monitoring to managing intricate interdependencies between terminals, synchronization requirements, and diverse operational policies. Traditional systems rely on static thresholds and reactive approaches that trigger warnings when cash levels reach predetermined limits, forcing immediate action often at inopportune times. This reactive approach is computationally inefficient as it fails to account for the complex matrix of constraints including sync level requirements across terminal groups, timing restrictions, ownership policies, lane format variations, and overflow handling rules. The computational complexity is further amplified by the need to simultaneously optimize across multiple competing objectives: minimizing the total number of cash management activities, maintaining appropriate cash levels across all terminals, reducing periods of degraded operation, and ensuring synchronized activities across specified terminal groups. Existing solutions lack the sophisticated computational frameworks needed to process these multi-dimensional constraint sets while maintaining practical implement ability within real-world retail operations. Additionally, the absence of labeled training data for “good” versus “bad” cash management decisions makes it computationally challenging to develop effective optimization strategies using traditional supervised learning approaches. These technical limitations result in suboptimal cash management that manifests in wasted labor hours, reduced terminal availability, and inefficient cash utilization across the terminal network.

While automated cash management systems exist, they lack sufficient inclusivity to support various modes of cash activity scheduling and aggregation. Different retailers employ diverse approaches to cash management, including variations in ownership (central versus store-level), replenishment sources (internal versus external), lane format applications, and overflow policies. Current systems do not adequately account for these operational constraints when generating cash management recommendations.

In various embodiments presented herein, a multi-model machine learning system enhances cash management optimization through an activity policy layer. A first machine learning model (MLM) generates optimal media baselines for individual terminals, while a second MLM incorporates sync level requirements and timing rules through reinforcement learning. This enables generation of practical, implementable cash management schedules that respect retailer-specific operational constraints while maintaining optimal cash levels.

In an embodiment presented herein, the methods and system incorporate “sync level” considerations for cash activities, determining the level of activity aggregation. This includes options for synchronized activities across all SCO terminals, specific subgroups of lanes, or subgroups of stores with separate management of recycler and overflow box operations.

In an embodiment, the methods and system accommodate different scheduling policies for time and frequency of cash activities. This includes day and hour-specific constraints, where activities may occur at any hour or only at specified times on particular days. Additionally, frequency-based policies allow activities to occur at any frequency or at specified intervals, such as every X days or Y weeks.

In an embodiment, the methods and system consider lane formats and hardware variations, accounting for both technical aspects (bin capacity, overflow usage per denomination) and business aspects (lanes deployed for different basket sizes). This comprehensive consideration ensures recommendations align with physical infrastructure limitations and business operational requirements.

As used herein, “an operational constraint” may be classified as a synchronization level constraint, a timing and frequency constraint, a cash management ownership constraint, a SCO terminal format and hardware constraint, and/or an overflow policy constraint. A synchronization level constraint includes requirements for same activities across all SCO terminals of a store, requirements for same activities across subgroups of SCO terminals, and/or requirements for same activities across subgroups of stores with separate management of a media recycler and media overflow box. A timing and frequency constraint includes restrictions on what days and hours media activities can occur, requirements for specific frequency of media activities (e.g., only every X days or Y weeks), and/or separate time frameworks for media recycler and media box overflow operations. A cash management ownership constraint includes central management policies applying to all stores and/or SCO terminals, store-level management policies, and/or internal versus external replenishment requirements (e.g., third-party service providers like Brinks® or Armourguard®). A SCO terminal and hardware constraint includes different SCO lane formats (e.g., express, basket, cart, etc.), technical limitations such as bin capacity, overflow usage restrictions per media denomination, and/or SCO lanes deployed for different basket sizes. An overflow policy constraint includes policies requiring higher value notes to go to overflow media bins, policies striving to recycle all media notes or cash, and/or different configurations for media overflow and media recycler operations.

As used herein, a “media activity” or a “media operation” may be categorized as cash replenishment activities, cash removal activities, and/or service activities. A cash replenishment activity includes adding media such as cash or coins to SCO terminals, and/or replenishing media denominations running low at cash or media recyclers of the SCO terminals. A cash removal activity includes removing excess media denominations from SCO terminals, removing media from overflow bins or cassettes of the SCO terminals, and/or clearing media overflow bins, boxes, or cassettes of the SCO terminals. A service activity includes cash-in-transit (CIT) service provider visits, cash pickup and delivery operations, and/or internal store staff cash handling operations.

In an embodiment, the media activities or media operations may be further categorized based on their execution requirements. The execution requirements may include activities that must be performed simultaneously across all SCO terminals, activities specific to certain SCO terminal or lane types, activities that can only be performed by specific personnel (i.e., store staff versus third-party services such is a CIT service), and/or activities that must follow specific timing or frequency constraints.

As used herein “valuable media,” “media,” and “cash” can be used interchangeably and synonymously. This is intended to mean currency, such as any government-backed notes/bills and/or any government-backed coins. A “media type” can either be a bill or a coin. Each media type includes its own unique denominations; for example, U.S.-backed currency includes bill type denominations of $1, $5, $10, $20, $50, and $100 and include coin type denominations of 1 cent, 5 cents, 10 cents, 25 cents, 50 cents, and $1.

The phrases and terms “a media baseline prediction,” “baseline prediction,” “baseline,” and “prediction” can be used interchangeably and synonymously. Each prediction includes calculated amounts of media per media denomination needed by a terminal of a store for purposes of minimizing future media activities on the corresponding terminal while also maintaining a minimum total media volume for the store's terminals as a whole at a requested point in time. An “optimal” media baseline prediction is a prediction provided by a trained MLM, as discussed herein and below.

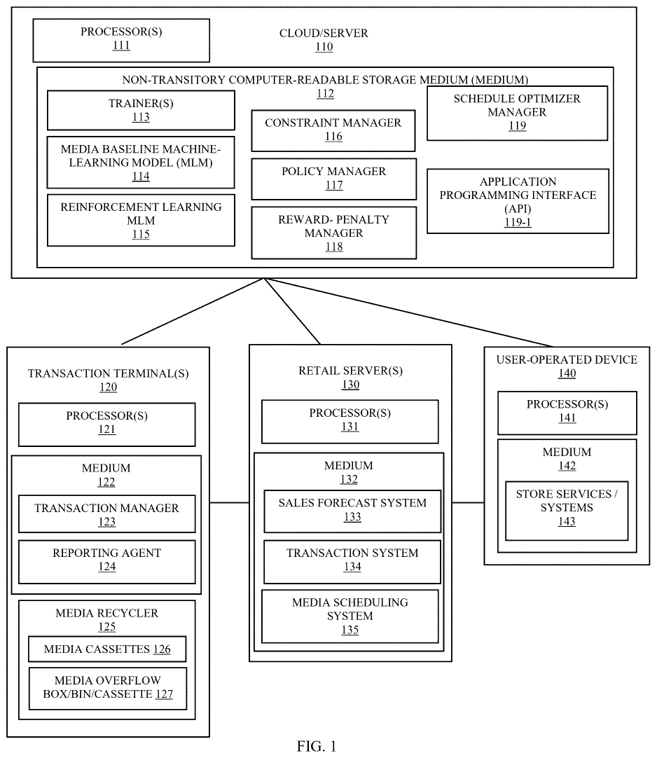

FIG. 1 is a diagram of a system 100 for terminal cash management optimization, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of real-time and dynamic terminal media management optimization presented herein and below.

System 100 includes a cloud 110 or a server 110 (hereinafter just “cloud 110” may also be referred to herein as “cloud server 110”), transaction terminals 120, one or more retail servers 130, and user-operated devices 140. Cloud 110 includes a processor 111 and a non-transitory computer-readable storage medium (medium) 112, which includes executable instructions for trainers 113, a media baseline MLM 114, a reinforcement learning MLM 115, a constraint manager 116, a policy manager 117, a reward-penalty manager 118, a schedule optimizer manager 119, and an application programming interface (API) 119-1. Processor 111 executes the instructions causing processor 111 to perform operations discussed herein and below with respect to 113-119-1.

Each transaction terminal 120 includes a processor 121 and a non-transitory computer-readable storage medium 122, which includes instructions for a transaction manager 123 and a reporting agent 124. Processor 121 executes the instructions causing processor 121 to perform operations discussed herein and below with respect to 123-124. Each terminal 120 also includes a media recycler 125. The media recycler 125 includes media cassettes 126 and a media overflow box/bin/cassette 127.

Each retailer server 130 includes a processor 131 and a non-transitory computer-readable storage medium 132, which includes executable instructions for a sales forecast system 133, a transaction system 134, and a media scheduling system 135. Processor 131 executes the instructions causing processor 131 to perform operations discussed herein and below with respect to 133-135.

Each user-operated device 140 includes a processor 141 and a non-transitory computer-readable storage medium 142, which includes instructions for one or more store services/systems 143. Processor 141 executes the instructions causing processor 141 to perform operations discussed herein and below with respect to 143.

A first trainer 113 trains media baseline MLM 114 on historical transaction and media data to produce media baselines for terminals 120 using actual observed media events, traffic patterns, and overall media volumes. MLM 114 is optimized to produce a media baseline for a given terminal 120 based on minimizing media activities while maintaining minimum total media value across all terminals 120 of a store.

A second trainer 113 trains the reinforcement learning MLM 115 using historical data to optimize cash management scheduling within operational constraints. The reinforcement learning MLM 115 receives media baselines from MLM 114, operational constraints from constraint manager 116, activity policy parameters from policy manager 117, and reward/penalty values from reward-penalty manager 118.

The constraint manager 116 maintains and processes different types of operational constraints including: sync level constraints specifying which terminals require synchronized activities, timing constraints defining when activities can occur, ownership constraints indicating whether store staff or third parties perform activities, lane format constraints based on terminal types, and overflow policy constraints for media handling requirements. The constraint manager 116 enables the reinforcement learning MLM 115 to generate schedules that respect the specific operational limitations of each retail environment while maintaining optimal cash management across all terminals.

The policy manager 117 handles activity policy parameters that define how retailers approach cash management, including central versus store-level management policies, internal versus external replenishment policies, and policies for different lane formats and overflow handling. These parameters establish the framework within which the reinforcement learning MLM 115 must operate.

The reward-penalty manager 118 assigns reward values when potential schedules satisfy operational constraints and penalty values when constraints are violated. For example, maintaining required synchronization across specified terminal groups earns rewards while failing to maintain synchronization incurs penalties. This reinforcement mechanism guides the MLM 115 toward optimal solutions within defined constraints.

The schedule optimizer manager 119 evaluates schedule options produced by MLM 115 to select optimal schedules that maximize rewards while minimizing penalties. The selected schedules specify timing and grouping of cash activities across terminals while respecting all operational constraints. The optimizer considers factors like predicted transaction volumes and dynamic thresholds when finalizing schedules. The sales forecast system 133 provides predicted transaction volumes and patterns to media baseline MLM 114, which uses this forecast data along with historical transaction data to generate optimal media baselines that account for expected future customer traffic and transaction levels. This enables the system 100 to proactively adjust media levels based on anticipated demand rather than just reacting to current conditions.

The API 119-1 integrates optimized schedules into the media scheduling system 135, enabling automated scheduling of cash activities. The API also provides schedule information to store services/systems 143, allowing managers to view and plan activities through user-operated devices 140.

The transaction manager 123 handles transaction processing on terminals 120 while the reporting agent 124 provides transaction and media metrics to both transaction system 134 and trainers 113. The reporting agent 124 monitors media levels in media cassettes 126 and a media overflow box/bin/cassette 127, tracking deposits, withdrawals and total media amounts.

The trainers 113 continuously process new transaction and media data from transaction system 134 to enable real-time adjustments to schedules. This adaptive approach allows the system 100 to maintain optimal cash management even as conditions change, while always operating within defined operational constraints and policies.

For purposes of illustration, an example implementation of the system components is now discussed. Consider a retail store with 10 SCO terminals divided into two groups: 6 express lane terminals and 4 full-service terminals. The store uses a third-party CIT service that can only perform cash activities on Tuesdays and Fridays between 8 AM and noon.

Initially, the media baseline MLM 114 processes historical transaction data and forecasts from sales forecast system 133 to determine optimal media levels for each terminal. The constraint manager 116 maintains the timing constraint (Tuesday/Friday 8 AM-noon) and sync level requirements (express lanes must be serviced together, full-service lanes must be serviced together). The policy manager 117 records that external CIT services handle high-value notes while store staff manages coin replenishment.

The reinforcement learning MLM 115 generates potential schedules, with reward-penalty manager 118 assigning rewards when activities are scheduled within the Tuesday/Friday window and penalties when activities fall outside these times. Additional rewards are given when express lanes are serviced together and full-service lanes are serviced together. The MLM 115 learns through reinforcement that scheduling express lanes for Tuesday mornings and full-service lanes for Friday mornings optimizes operations while respecting all constraints.

The schedule optimizer manager 119 evaluates these recommendations against real-time conditions. For example, if transaction volumes are higher than predicted, the optimizer may adjust the schedule to include both express and full-service lanes on Tuesday morning. The optimized schedule is then transmitted through API 119-1 to the media scheduling system 135 for execution and to store services/systems 143 for management visibility.

This example demonstrates how the system components work together to generate practical, implementable schedules that respect both physical constraints (terminal groupings) and temporal constraints (service windows) while maintaining optimal cash levels across all terminals. The integrated approach enables retailers to efficiently manage cash operations within their specific operational framework while minimizing labor costs and maximizing terminal availability.

In an embodiment, terminals 120 are SCO terminals used for self-checkouts. In an embodiment, terminals 120 are a combination of SCO terminals and point-of-sale (POS) terminals where cashiers do not have a cash box but rather rely on a recycler to deposit and dispense cash. In this way, system 100 may be used for just SCO terminals of a store or used with both SCO and POS terminals of a store.

In various embodiments, the MLMs (114 and 115) may be implemented using different types of machine learning architectures. The media baseline MLM 114 may utilize Gradient Boosting Models like XGBoost or LightGBM for time-series forecasting, Long Short-Term Memory (LSTM) networks for capturing long-term patterns, or Random Forest models for robust prediction with multiple variables. The reinforcement learning MLM 115 may employ Deep Q-Networks (DQN), Proximal Policy Optimization (PPO) algorithms, or Actor-Critic architectures for balancing exploration and exploitation in schedule optimization.

In an embodiment, the reinforcement learning MLM 115 utilizes a Deep Q-Network (DQN) architecture to learn optimal scheduling policies. The DQN processes state information including current media levels, operational constraints, and predicted transaction volumes to generate Q-values for possible scheduling actions. The model is trained using experience replay to learn from past scheduling decisions and their outcomes, with the reward-penalty manager 118 providing feedback signals for policy improvement.

In an embodiment, the system 100 employs multiple specialized MLMs (114 and 115) working in concert to optimize cash management. The media baseline MLM 114 uses Long Short-Term Memory (LSTM) networks to process historical transaction patterns and sales forecast data from sales forecast system 133, capturing both short-term fluctuations and long-term seasonal patterns in customer behavior to generate accurate media baselines. These baseline predictions are then fed into the reinforcement learning MLM 115, which implements a Deep Q-Network (DQN) architecture to learn optimal scheduling policies within operational constraints. The DQN processes state information including current media levels, constraint parameters from constraint manager 116, and policy requirements from policy manager 117 to generate Q-values for possible scheduling actions. The reward-penalty manager 118 provides feedback signals that guide the DQN's learning process, while experience replay mechanisms enable the model to learn from past scheduling decisions and their outcomes. For complex multi-terminal synchronization requirements, the schedule optimizer manager 119 employs a Proximal Policy Optimization (PPO) algorithm to maintain stable learning when balancing competing constraints across multiple terminals while preventing policy updates from deviating too far from previously successful strategies.

In an embodiment, the integration of reinforcement learning with specialized MLM architectures represents a significant advancement in media management technology. Unlike traditional MLM approaches that rely solely on supervised learning of historical data, the reinforcement learning MLM 115 enables dynamic optimization through real-time reward and penalty signals, allowing the system 100 to learn optimal scheduling policies without requiring labeled training data of “good” versus “bad” cash management decisions. This is particularly valuable since existing cash management data often reflects suboptimal reactive practices rather than ideal proactive scheduling. The system 100 further improves MLM technology through its novel multi-model architecture, where the media baseline MLM 114 generates foundational predictions that are then refined through the reinforcement learning process, enabling the system 100 to balance competing objectives while respecting complex operational constraints. The reward-penalty mechanism allows the MLMs (114 and 115) to learn from trial and error rather than requiring extensive pre-labeled training data, making the system 100 more adaptable to different retail environments and operational frameworks. Additionally, the integration of synchronization level requirements and timing rules through the reinforcement learning framework enables the MLMs (114 and 115) to discover scheduling patterns that would be difficult to identify through traditional supervised learning approaches.

In an embodiment, the constraint manager 116 improves computer functionality through its novel approach to constraint processing and optimization. Rather than using traditional rule-based systems that rigidly apply constraints, the constraint manager 116 implements a dynamic constraint handling framework that enables real-time adaptation of scheduling parameters. The constraint manager 116 maintains separate processing streams for different constraint types (sync level, timing, ownership, format, and overflow), allowing parallel evaluation of multiple constraint categories while preventing constraint conflicts that could deadlock traditional systems. This specialized architecture enables the reinforcement learning MLM 115 to efficiently explore the constrained solution space by dynamically adjusting reward signals based on constraint satisfaction levels. The constraint manager 116 further improves processing efficiency by maintaining separate constraint frameworks for recycler and overflow operations, allowing independent optimization of these subsystems while ensuring synchronization when required by policy parameters. Additionally, the constraint manager 116 implements a hierarchical constraint evaluation system that prioritizes critical operational requirements (like sync level constraints) while flexibly handling lower-priority constraints, enabling the system 100 to find optimal solutions even in highly constrained environments where traditional approaches would fail to converge. This technical implementation enables the system 100 to process complex, multi-dimensional constraint sets more efficiently than conventional approaches, while ensuring generated schedules remain practically implementable within real-world retail operations.

In an embodiment, the policy manager 117 provides technical improvements through its sophisticated policy parameter processing framework that enhances machine learning efficiency. Unlike conventional policy management systems that handle policies as static rules, the policy manager 117 implements a dynamic policy framework that enables real-time adaptation of scheduling parameters based on different management approaches (central versus store-level) and replenishment sources (internal versus external). The policy manager 117 employs an innovative policy translation mechanism that converts high-level business policies into quantifiable parameters that can be efficiently processed by the reinforcement learning MLM 115, enabling automated discovery of optimal scheduling patterns within policy boundaries. This technical implementation significantly improves processing efficiency by maintaining separate policy frameworks for different management levels while ensuring coherent optimization across the entire system 100. The policy manager 117 further enhances system performance through its adaptive policy evaluation system that automatically adjusts scheduling constraints based on policy requirements for different lane formats and overflow handling configurations. Additionally, the policy manager 117 implements a hierarchical policy processing architecture that enables parallel evaluation of multiple policy requirements while preventing policy conflicts that could impair traditional scheduling systems, allowing the MLM to quickly converge on optimal solutions that satisfy all policy requirements.

In an embodiment, the reward-penalty manager 118 provides technical improvements to machine learning technology through its novel approach to reinforcement learning optimization. Unlike conventional reinforcement learning systems that use fixed reward structures, the reward-penalty manager 118 implements an adaptive reward mechanism that dynamically adjusts based on multiple constraint satisfaction levels and operational outcomes. The reward-penalty manager 118 employs a sophisticated multi-tier reward structure where rewards and penalties are calculated not just for individual scheduling decisions, but for the emergent patterns of synchronized activities across terminal groups. This enables the reinforcement learning MLM 115 to discover complex scheduling patterns that would be difficult to identify through traditional supervised learning approaches. The reward-penalty manager 118 further enhances learning efficiency by maintaining separate reward frameworks for recycler and overflow operations while implementing a unified reward calculation system that ensures coherent optimization across both subsystems. Additionally, the reward-penalty manager 118 employs an innovative feedback mechanism that allows real-time adjustment of reward weights based on operational outcomes, enabling the MLM 115 to continuously refine its scheduling policies without requiring manual retraining or parameter tuning. This technical implementation significantly improves the speed and effectiveness of the MLM training process by enabling automated discovery of optimal scheduling patterns while maintaining strict adherence to operational constraints.

In an embodiment, the schedule optimizer manager 119 provides technical improvements through its innovative approach to multi-terminal coordination and schedule optimization. Unlike traditional scheduling systems that optimize terminals independently, the schedule optimizer manager 119 implements a hierarchical optimization framework that considers both individual terminal requirements and system-wide synchronization constraints simultaneously. The schedule optimizer manager 119 employs an advanced scheduling algorithm that processes potential schedule options from the reinforcement learning MLM 115 while dynamically balancing multiple competing factors including predicted transaction volumes, real-time media levels, and sync level requirements across terminal groups. This technical implementation enables more efficient processing of complex scheduling scenarios by maintaining separate optimization paths for synchronized terminal groups while ensuring coherent scheduling across the entire system. The schedule optimizer manager 119 further enhances system performance through its dynamic threshold adjustment mechanism, which automatically modifies scheduling parameters based on real-time conditions and predicted transaction patterns from the sales forecast system 133. Additionally, the schedule optimizer manager 119 implements an innovative schedule evaluation framework that enables rapid assessment of multiple schedule options against operational constraints, allowing the system 100 to quickly identify and select optimal schedules that maximize terminal availability while minimizing labor costs and service disruptions.

In an embodiment, system 100 provides multiple integrated technical improvements that transform abstract cash management concepts into a practical and efficient computing solution. The multi-model machine learning architecture represents a significant advancement by combining specialized LSTM networks for baseline prediction with an innovative DQN-based reinforcement learning approach that enables dynamic optimization without requiring labeled training data. The constraint manager 116 improves computer functionality through its parallel constraint processing streams and hierarchical evaluation framework, allowing efficient exploration of complex solution spaces while preventing constraint conflicts that would deadlock traditional systems. The reward-penalty manager 118 enhances machine learning technology through its adaptive reward mechanism and multi-tier structure that enables automated discovery of optimal scheduling patterns across synchronized terminal groups. The schedule optimizer manager 119 provides technical improvements through its hierarchical optimization framework that simultaneously processes individual terminal requirements and system-wide synchronization constraints while maintaining separate optimization paths for terminal groups. The policy manager 117 implements an innovative policy translation mechanism that converts high-level business policies into quantifiable parameters, significantly improving processing efficiency through its hierarchical architecture that enables parallel evaluation of multiple policy requirements. Together, these components form an integrated system 100 that improves upon conventional machine learning and scheduling technologies by enabling efficient processing of complex multi-terminal coordination problems while maintaining strict adherence to operational constraints. The system's technical implementation provides concrete improvements in processing efficiency, scheduling optimization, and machine learning capabilities that go beyond merely implementing abstract ideas on generic computing components.

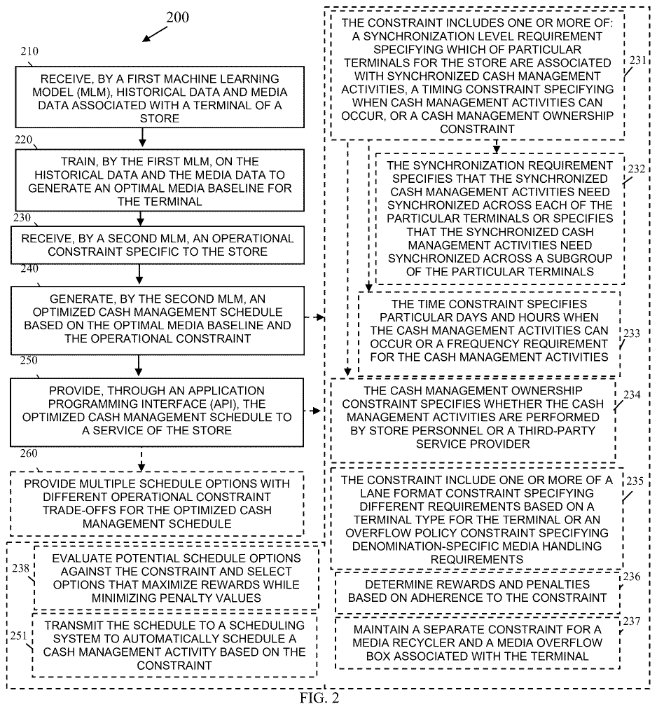

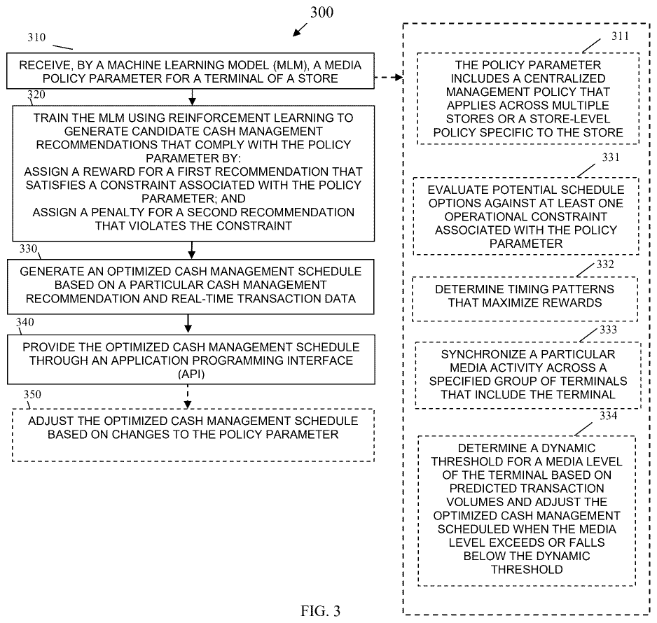

Having described the components and operations of system 100 in detail, including an example implementation demonstrating the practical application of the various components, methods for optimizing cash management activities through operational constraints and reinforcement learning are now presented with reference to FIGS. 2 and 3. These methods illustrate specific processes executed by the components of system 100 to generate optimized cash management schedules that respect retailer-specific operational constraints while maintaining optimal cash levels across terminals. The methods particularly demonstrate how the reinforcement learning approach enables dynamic optimization of scheduling within operational constraints through the use of rewards and penalties.

FIG. 2 illustrates a flow diagram of a method 200 for terminal cash management optimization of a transaction terminal, according to an example embodiment. The software module(s) that implements the method 200 is referred to as a “terminal media scheduler.” The terminal media scheduler is implemented as executable instructions programmed and residing within memory and/or a non-transitory computer-readable (processor-readable) storage medium and executed by one or more processors of one or more devices. The processor(s) of the device(s) that executes the terminal media scheduler are specifically configured and programmed to process the terminal media scheduler. The terminal media scheduler has access to one or more network connections during its processing. The connections can be wired, wireless, or a combination of wired and wireless.

In an embodiment, the device that executes terminal media scheduler is cloud 110. In an embodiment, the device that executes terminal media scheduler is server 110. In an embodiment, the devices that executes terminal media scheduler is a retail server 130. In an embodiment, the terminal media scheduler is all of, or some combination of 113-119-1. In an embodiment, the terminal media scheduler is provided to a retail server 130 and/or a user-operated device 140 as a software-as-a-service (SaaS).

At 210, the terminal media scheduler receives at a first MLM 114 historical data and media data associated with a terminal 120 of a store. At 220, the terminal media scheduler trains the first MLM 114 on the historical data and the media data to generate an optimal media baseline for the terminal.

At 230, the terminal media scheduler receives at a second MLM 115 at least one operational constraint specific to the store. In an embodiment, at 231, the constraint includes one or more of: a synchronization level requirement specifying which of particular terminals 120 for the store are associated with synchronized cash management activities, a timing constraint specifying when cash management activities can occur, or a cash management ownership constraint. In an embodiment, at 232, the synchronization level requirement specifies that the synchronized cash management activities need synchronized across each of particular terminals 120 or specifies that the synchronized cash management activities need synchronized across a subgroup of the particular terminals 120.

In an embodiment, at 233, the time constraint specifies particular days and hours when the cash management activities can occur or a frequency requirement for the cash management activities. In an embodiment, at 234, the cash management ownership constraint specifies whether the cash management activities are performed by store personnel or a third-party service provider. In an embodiment, at 235, the constraint includes one or more of: a lane format constraint specifying different requirements based on a terminal type for the terminal 120 or an overflow policy constraint specifying denomination-specific media handling requirements.

In an embodiment, at 236, the terminal media scheduler determines rewards and penalties based on adherence to the constraint. In an embodiment, at 237, the terminal media scheduler maintains a separate constraint for media cassettes 126 of a media recycler 125 and a media overflow box/bin/cassette 127 associated with the terminal 120. In an embodiment, at 238, the terminal media scheduler evaluates potential schedule options against the constraint and the terminal media scheduler selects options that maximize rewards while minimizing penalty values.

At 240, the terminal media scheduler using the second MLM 115 generates an optimized cash management schedule based on the optimal media baseline and the operational constraint. At 250, the terminal media scheduler provides, through an API 119-1, the optimized cash management scheduled to a service 143 of the store.

In an embodiment, at 251, the terminal media scheduler transmit the optimized cash management schedule to a media scheduling system 135 of the store to automatically schedule at least one cash management activity based on the constraint. In an embodiment, at 260, the terminal media scheduler provides multiple schedule options with different operational constraint trade-offs for the optimized cash management schedule.

FIG. 3 illustrates a flow diagram of another method 300 for terminal cash management optimization of a transaction terminal, according to an example embodiment. The software module(s) that implements the method 300 is referred to as a “terminal media activity schedule optimizer.” The terminal media activity schedule optimizer is implemented as executable instructions programmed and residing within memory and/or a non-transitory computer-readable (processor-readable) storage medium and executed by one or more processors of one or more devices. The processor(s) of the device(s) that executes the terminal media activity schedule optimizer are specifically configured and programmed to process the terminal media activity schedule optimizer. The terminal media activity schedule optimizer has access to one or more network connections during its processing. The network connections can be wired, wireless, or a combination of wired and wireless.

In an embodiment, the device that executes the terminal media activity schedule optimizer is cloud 110. In an embodiment, the device that executes the terminal media activity schedule optimizer is server 110. In an embodiment, the device that executes the terminal media activity schedule optimizer is retail server 130. In an embodiment, the terminal media activity schedule optimizer is provided to a retail server 130 and/or a user-operated device 140 as a SaaS.

In an embodiment, the terminal media activity schedule optimizer is all of, or some combination of 113-119-1, and/or method 200. The terminal media activity schedule optimizer presents another and, in some ways, enhanced processing perspective from that which was discussed above with the method 200 of the FIG. 2.

At 310, the terminal media activity schedule optimizer receives at a MLM 115 a policy parameter for a terminal 120. In an embodiment, at 311, the policy parameter includes a centralized management policy that applies across multiple stores or a store-level policy specific to the store.

At 320, the terminal media activity schedule optimizer trains the MLM 115 using reinforcement learning to generate candidate cash management recommendations that comply with the media policy parameter. The terminal media activity schedule optimizer trains the MLM 115 by assigning a reward for a first recommendation that satisfies a constraint associated with the media policy parameter and assigns a penalty for a second recommendation that violates the constraint.

At 330, the terminal media activity schedule optimizer generates an optimized cash management schedule based on a particular cash management recommendation and real-time transaction data. In an embodiment, at 331, the terminal media activity schedule optimizer evaluates potential schedule options against at least one operational constraint associated with the media policy parameter.

In an embodiment, at 332, the terminal media activity schedule optimizer determines timing patterns that maximize rewards. In an embodiment, at 333, the terminal media activity schedule optimizer synchronizes a particular media activity across a specified group of terminals that include the terminal 120. In an embodiment, at 334, the terminal media activity schedule optimizer determines a dynamic threshold for a media level of the terminal based on predefined transaction volumes. The terminal media activity schedule optimizer adjusts the optimized cash management scheduled when the media level exceeds or falls below the dynamic threshold.

At 340, the terminal media activity schedule optimizer provides the optimized cash management schedule through an API 119-1. In an embodiment, at 350, the terminal media activity schedule optimizer adjusts the optimized cash management schedule based on changes to the media policy parameter.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, by a first machine learning model (MLM) executing on a processor of a cloud server, historical transaction and media data associated with a terminal of a store;
training, by the first MLM, on the historical transaction and media data to generate an optimal media baseline for the terminal;
receiving, by a second MLM executing on the processor, at least one operational constraint specific to the store;
generating, by the second MLM using reinforcement learning, an optimized cash management schedule based on the optimal media baseline and the at least one operational constraint; and
providing, through an application programming interface (API), the optimized cash management schedule to a service of the store.

2. The method of claim 1, wherein the at least one operational constraint includes one or more of: a synchronization level requirement specifying which of particular terminals for the store are associated with synchronized cash management activities, a timing constraint specifying when cash management activities can occur, or a cash management ownership constraint.

3. The method of claim 2, wherein the synchronization level requirement specifies that synchronized cash management activities need synchronized across each of the particular terminals or specifies that the synchronized cash management activities need synchronized across a subgroup of the particular terminals.

4. The method of claim 2, wherein the timing constraint specifies particular days and hours when the cash management activities can occur or specifies a frequency requirement for the cash management activities.

5. The method of claim 2, wherein the cash management ownership constraint specifies whether the cash management activities are performed by store personnel or a third-party service provider.

6. The method of claim 1, wherein the at least one operational constraint includes one or more of a lane format constraint specifying different requirements based on a terminal type of the terminal or an overflow policy constraint specifying denomination-specific media handling requirements.

7. The method of claim 1, wherein generating includes determining rewards and penalties based on adherence to the at least one operational constraint.

8. The method of claim 1, wherein generating includes maintaining at least one separate operational constraint for a media recycler and a media overflow box associated with the terminal.

9. The method of claim 1, wherein generating includes evaluating potential schedule options against the at least one operational constraint and selecting options that maximize reward values while minimizing penalty values.

10. The method of claim 1, wherein providing includes transmitting the optimized cash management schedule to a media scheduling system of the store to automatically schedule a cash management activity based on the at least one operational constraint.

11. The method of claim 1, further comprising providing multiple schedule options with different operational constraint trade-offs for the optimized cash management schedule.

12. A method, comprising:
receiving, by a machine learning model (MLM) executing on a processor of a cloud server, a media activity policy parameter for a terminal of a store;
training the MLM using reinforcement learning to generate candidate cash management recommendations that comply with the media activity policy parameter, wherein training includes:
assigning a reward for a first recommendation that satisfies at least one operational constraint associated with the media activity policy parameter; and
assigning a penalty for a second recommendation that violates the at least one operational constraint;
receiving real-time transaction data from the terminal;
generating an optimized cash management schedule based on a particular cash management recommendation and the real-time transaction data; and
providing the optimized cash management schedule through an application programming interface (API).

13. The method of claim 12, wherein the media activity policy parameter includes a centralized management policy that applies across multiple stores or a store-level policy specific to the store.

14. The method of claim 12, wherein generating includes evaluating potential schedule options against at least one operational constraint associated with the media activity policy parameter.

15. The method of claim 12, wherein generating includes determining timing patterns that maximize reward values.

16. The method of claim 12, wherein generating includes synchronizing a particular media activity across a specified group of terminals that includes the terminal.

17. The method of claim 12, wherein generating includes determining a dynamic threshold for a media level of the terminal based on predicted transaction volumes and adjusting the optimized cash management schedule when the media level exceeds or falls below the dynamic threshold.

18. The method of claim 12, further comprising adjusting the optimized cash management schedule based on changes to the media activity policy parameter.

19. A system, comprising:
a cloud server comprising at least one processor and a non-transitory computer-readable storage medium;
the non-transitory computer-readable storage medium comprises executable instruction; and
the executable instruction when executed by the at least one processor from the non-transitory computer-readable storage medium cause the at least one processor to perform operations comprising:
receiving a media activity policy parameter that defines a synchronization level constraint for a cash management activity at a terminal of a store;
training a reinforcement machine learning model (MLM) to optimize cash management scheduling by:
evaluating a potential schedule against the synchronization level constraint;
assigning a reward value when the potential schedule maintains synchronization across a specified group of terminals that includes the terminal;
assigning a penalty value when the potential schedule fails to maintain synchronization across the specified group of terminals; and
selecting a schedule option that maximizes the reward value;
generating an optimized cash management schedule based on a selected schedule option and real-time transaction data from the terminal; and
providing the optimized cash management schedule through an application programming interface (API) to automatically schedule the cash management activity.

20. The system of claim 19, wherein the operations further comprise maintaining a separate synchronization level requirement for a media recycler and a media overflow box of the terminal, and wherein the reinforcement MLM evaluates the potential schedule against each separate synchronization level requirement.
